(19) United States
(12) Patent Application Publication
(10) Pub. No.: US 2025/0265824 A1
(43) Pub. Date: Aug. 21, 2025

(54) APPARATUS AND METHOD FOR SELF-SUPERVISED CONTRASTIVE LEARNING

(71) Applicant: ELECTRONICS AND TELECOMMUNICATIONS RESEARCH INSTITUTE, Daejeon (KR)

(72) Inventors: Jeun Woo Lee, Daejeon (KR); Dong-oh Kang, Daejeon (KR); MINHO PARK, Daejeon (KR); Hyun Woo Kim, Daejeon (KR); Hwa Jeon Song, Daejeon (KR)

(21) Appl. No.: 19/050,519

(22) Filed: Feb. 11, 2025

(30) Foreign Application Priority Data
Feb. 21, 2024 (KR) 10-2024-0024934

(51) Int. Cl. G06V 10/774; G06V 10/764; G06V 10/776; G06V 10/82

(52) U.S. Cl. CPC G06V 10/774; G06V 10/764; G06V 10/776; G06V 10/82

(57) ABSTRACT

Disclosed is a method for self-supervised contrastive learning. The method may include generating a plurality of different view images by applying at least one conversion scheme for contrastive learning to a pre-stored non-index object image, generating expression vectors by alternately inputting the plurality of view images to a backbone network and a momentum network initialized to have an identical network parameter values, classifying the plurality of view images into a positive sample and a negative sample based on an anchor vector selected in a batch of the expression vectors, calculating a loss value of a loss function based on a distance value between the anchor vector and the expression vector, and updating parameters of the backbone network and the momentum network by reversely propagating the loss value of the loss function to the backbone network.

### CROSS-REFERENCE TO RELATED APPLICATION(S)

This application claims priority from and the benefit of Korean Patent Application No. 10-2024-0024934, filed on Feb. 21, 2024, which is hereby incorporated by reference for all purposes as if set forth herein.

### BACKGROUND

### 1. Technical Field

The present disclosure relates to an apparatus and method for self-supervised contrastive learning and, more particularly, to an apparatus and method for self-supervised contrastive learning (SSCL), which learn visual expressions of an image.

### 2. Description of Related Art

With the advance of the deep learning technology, an object classification technology that classifies persons, dogs, and vehicles within an image has performance that exceeds a person's capacity. In order to apply the deep learning technology more widely, recently, for example, attention is focused on more precise object classification, such as identifying a fashion style by classifying detailed attributes, such as the type, form, and decoration of clothing worn by a person.

A conventional object classification system based on deep learning essentially requires a large amount of high-quality learning data to which accurate indices have been attached for higher performance of a recognizer. However, it is difficult to obtain a sufficient amount of learning data because a lot of costs are required for an index task in order to secure such data. As an alternative for such a problem, there are presented SSCL methods, such as a simple framework for contrastive learning of visual representations (SimCLR) and Bootstrap Your Own Latent (BYOL) having excellent classification performance while using non-index learning data.

In the SSCL methods, various conversion schemes are applied in order to expand the same image to several visual perspectives. Two or more views may be generated by applying various conversions, such as partial cutting, size conversion, rotation, a color change, and noise addition, several times through the conversion schemes. Views that are converted into the same original image are considered as positive samples and used in learning between homogeneous classes. Views that are converted into different images are treated as negative samples and used in learning between heterogeneous classes.

An aspect to note in such a learning approach is a case in which a positive sample (i.e., a hard positive sample) has a more different feature value than a negative sample based on features of a collected image and an applied conversion method frequently occurs and a case in which a negative sample (i.e., a hard negative sample) has a more similar feature value than a positive sample because views need to be classified as a homogeneous class, but are converted from different images and learnt as a negative sample also frequently occurs.

In the SSCL methods, as learning is in progress, similarity between positive samples included in a homogeneous class is maximized and similarity between negative samples included in a heterogeneous class is minimized. However, as a hard positive sample and a hard negative sample are increased, learning efficiency is reduced. This may lead to degraded performance of a classifier after learning is completed and a long learning time. In particular, there is a difficulty in applying the existing simple positive and negative sample classification methods to cases, such as a fashion, clothing, and subspecies of a dog having high similarity between classes. In addition, as is well known, when using a large batch size to increase learning efficiency, the number of difficult negative samples increases significantly, and the desired learning efficiency does not increase as much as expected.

### PRIOR ART DOCUMENT

### Patent Document

Korean Patent Application Publication No. 10-2023-0087816 (Jun. 19, 2023)

### SUMMARY

Various embodiments are directed to providing an apparatus and method for self-supervised contrastive learning (SSCL) in which similarity between augmentation data is checked and incorporated into learning so that a classifier having high classification performance can be constructed based on a non-index dataset for learning, which has a low construction cost compared to an indexed dataset for learning.

However, objects of the present disclosure to be achieved are not limited to the aforementioned object, and other objects may be present.

A method for self-supervised contrastive learning (SSCL) according to a first aspect of the present disclosure may include generating a plurality of different view images by applying at least one conversion scheme for contrastive learning to a pre-stored non-index object image, generating expression vectors by alternately inputting the plurality of view images to a backbone network and a momentum network initialized to have an identical network parameter values, classifying the plurality of view images into a positive sample and a negative sample based on an anchor vector selected in a batch of the expression vectors, calculating a loss value of a loss function based on a distance value between the anchor vector and the expression vector, and updating parameters of the backbone network and the momentum network by reversely propagating the loss value of the loss function to the backbone network.

Furthermore, an apparatus for self-supervised contrastive learning (SSCL) according to a second aspect of the present disclosure may include an image data repository configured to store non-index object images necessary for learning, an image data augmentator configured to generate a plurality of different view images by applying at least one conversion scheme for contrastive learning to the non-index object image, a backbone network and a momentum network each configured to generate expression vectors by alternately receiving the plurality of view images and initialized to have an identical network parameter values, an expression vector repository configured to store the expression vectors generated by the backbone network and the momentum network, a sample checker configured to classify the plurality of view images into a positive sample and a negative sample based on an anchor vector selected in a batch of the expression vectors, and a loss calculator configured to calculate a loss value of a loss function based on a distance value between the anchor vector and the expression vector and to update parameters of the backbone network and the momentum network by reversely propagating the loss value of the loss function to the backbone network.

Furthermore, an apparatus for self-supervised contrastive learning (SSCL) according to a second aspect of the present disclosure may include memory in which a non-index object image necessary for learning, an expression vector corresponding to the non-index object image, and a program for SSCL based on the non-index object image are stored and a processor configured to execute the program stored in the memory. By executing the program, the processor generates a plurality of different view images by applying at least one conversion scheme for SSCL to the non-index object image, generates expression vectors by alternately inputting the plurality of view images to a backbone network and a momentum network initialized to have an identical network parameter values, classifies the plurality of view images into a positive sample and a negative sample based on an anchor vector selected in a batch of the expression vectors, calculates a loss value of a loss function based on a distance value between the anchor vector and the expression vector, and updates parameters of the backbone network and the momentum network by reversely propagating the loss value of the loss function to the backbone network.

A computer program according to another aspect of the present disclosure executes the apparatus and method for SSCL and is stored in a computer-readable recording medium.

Other details of the present disclosure are included in the detailed description and the drawings.

Embodiments of the present disclosure provide an efficient learning method in non-index image data by using the SSCL technology, and may achieve excellent learning performance while reducing a burden of a cost for data indexing.

Furthermore, a loss value is calculated by checking the expression vector of each view generated by the augmenter and dividing the expression vector as a positive sample and a negative sample. In this case, there is an advantage in that performance can be improved and a learning time can be reduced, compared to the existing learning method of simply classifying views derived from the same image as a positive sample and simply classifying views derived from a different image as a negative sample. In particular, excellent performance can be guaranteed with the detailed classification of attributes even in a situation having high similarity between classes, such as fashion and clothing classification.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a construction diagram of an apparatus for self-supervised contrastive learning (SSCL) according to an embodiment of the present disclosure.

FIG. 2 is a block diagram of the apparatus for SSCL according to an embodiment of the present disclosure.

FIG. 3 is a flowchart of a method for SSCL according to an embodiment of the present disclosure.

FIGS. 4A and 4B are diagrams for describing a process of selecting an anchor vector and a process of classifying a positive sample and a negative sample in an embodiment of the present disclosure.

FIG. 5 is a diagram for describing a sample classification process in a view image different from an anchor vector in an embodiment of the present disclosure.

FIG. 6 is a diagram illustrating a flow of an operation that is performed by a sample checker and a loss calculator according to an embodiment of the present disclosure.

### DETAILED DESCRIPTION

Advantages and characteristics of the present disclosure and a method for achieving the advantages and characteristics will become apparent from the embodiments described in detail later in conjunction with the accompanying drawings. However, the present disclosure is not limited to embodiments disclosed hereinafter, but may be implemented in various different forms. The embodiments are merely provided to complete the present disclosure and to fully notify a person having ordinary knowledge in the art to which the present disclosure pertains of the category of the present disclosure. The present disclosure is merely defined by the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element. Throughout the specification, the same reference numerals denote the same elements. “And/or” includes each of mentioned elements and all combinations of one or more of mentioned elements. Although the terms “first”, “second”, etc. are used to describe various components, these elements are not limited by these terms. These terms are merely used to distinguish between one element and another element. Accordingly, a first element mentioned hereinafter may be a second element within the technical spirit of the present disclosure.

All terms (including technical and scientific terms) used in this specification, unless defined otherwise, will be used as meanings which may be understood in common by a person having ordinary knowledge in the art to which the present disclosure pertains. Furthermore, terms defined in commonly used dictionaries are not construed as being ideal or excessively formal unless specially defined otherwise.

Embodiments of the present disclosure relate to an apparatus and method for self-supervised contrastive learning (SSCL). Embodiments of the present disclosure are intended to solving problems, such as degraded performance of SSCL learning and a long learning time attributable to an increase of a hard positive sample (or a hard positive sample) and a hard negative sample that are generated when SSCL is applied to the existing classification of detailed attributes having great similarity between classes.

Embodiments of the present disclosure may provide an apparatus and method for SSCL, which check a negative sample converted from an image that belongs to a different image, but belongs to a homogeneous class and a positive sample having statistical characteristics greatly changed due to an image conversion, such as partial cutting, based on similarity between the negative sample and the positive sample in a learning process and enable image objects having great similarity between classes to be classified with high performance.

Furthermore, embodiments of the present disclosure may provide an apparatus and method for SSCL, which can effectively train a classifier for a high degree of a classification task that in general, requires expert knowledge by using a large amount of cheap non-index learning data based on SSCL.

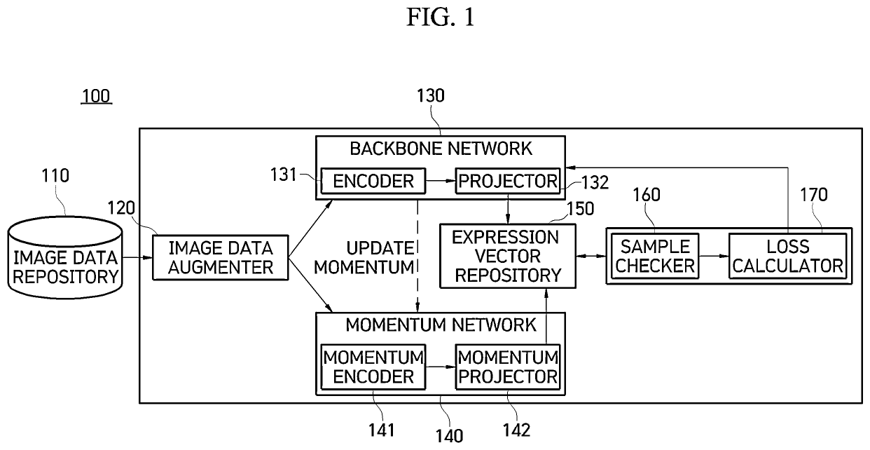

FIG. 1 is a construction diagram of an apparatus 100 for self-supervised contrastive learning (SSCL) according to an embodiment of the present disclosure.

The apparatus 100 for SSCL according to an embodiment of the present disclosure includes an image data repository 110, an image data augmenter 120, a backbone network 130, a momentum network 140, an expression vector repository 150, a sample checker 160, and a loss calculator 170.

The image data repository 110 stores a non-index object image necessary for learning. That is, in an embodiment of the present disclosure, learning is performed on a non-index object image not having a special index or label. According to an embodiment, the image data repository 110 may be constructed independently of the apparatus 100 for SSCL.

The image data augmenter 120 generates a plurality of different view images by applying at least one conversion scheme for SSCL to a non-index object image. The image data augmenter 120 generates the batch of image data to be used for learning from the image data repository 110, and generates at least two different view images by applying at least one of several conversion schemes that are used in a common contrastive learning scheme to each non-index object image. Examples of the conversion scheme include “arbitrary part cutting and size adjustment”, “color jittering”, “rotation”, and “blurring”.

The backbone network 130 and the momentum network 140 generate expression vectors by alternately receiving a plurality of view images.

In the description of the present disclosure, it is assumed that the image data augmenter 120 generates two view images and inputs the two view images to the backbone network 130 and the momentum network 140, respectively, for convenience sake, but the present disclosure is not essentially limited thereto.

The backbone network 130 and the momentum network 140 may each be composed of a deep neural network having the same structure. In an embodiment, the backbone network 130 and the momentum network 140 are initialized to have the same network parameter values, and each convert an input view image into an expression vector. In this case, in the initialization, a weight value of pre-trained network may be applied as a large amount of image datasets, such as an image net.

The backbone network 130 includes an encoder 131 and a projector 132. The encoder 131 may generate a common feature vector from a view image by using a deep neural network structure that is used in common SSCL. The projector 132 may use a multi-layer neural network having one or two hidden layers in order to convert such a feature vector into a vector that is adjusted to be suitable for contrastive learning.

The momentum network 140 includes a momentum encoder 141 and a momentum projector 142. In this case, the momentum encoder 141 and the momentum projector 142 update their weights in a momentum manner as in Equation 1 and Equation 2 so that the momentum network 140 is trained more stably.

$${θ}_{menc} = m {θ}_{enc} + ( 1 - m ) {θ}_{menc} \qquad ( 1 )$$

$${θ}_{mproj} = m {θ}_{proj} + ( 1 - m ) {θ}_{mproj} \qquad ( 2 )$$

In Equation 1, θ_{enc} indicates the parameter of the encoder 131, and θ_{menc} indicates the parameter of the momentum encoder 141. m is a momentum coefficient and is a number (e.g., 0.999) that is proximate to 1. Furthermore, in Equation 2, θₚᵣₒⱼ is the parameter of the projector 132, and θₘₚᵣₒⱼ is the parameter of the momentum projector 142.

The expression vector repository 150 stores the expression vectors generated by the backbone network 130 and the momentum network 140. Table 1 indicates a data structure that is stored in the expression vector repository 150.

TABLE 1

| | | SAME | | | DISTANCE |
|---|---|---|---|---|---|
| | IMAGE | ORIGINAL | VECTOR | TYPE | Sᵢⱼ |
| VECTOR | UNIQUE | IMAGE | STORAGE | OF | FROM |
| NUMBER | ID | GROUP | LOCATION | SAMPLE | ANCHOR |
| 1 | /img001.jpg | 1 | P-vector1 | 2 | 1 |
| 2 | /img001.jpg | 1 | P-vector2 | 0 | |
| 3 | /img002.jpg | 3 | P-vector3 | 2 | 1 |
| 4 | /img002.jpg | 3 | P-vector4 | 1 | |
| . . . | . . . | | . . . | . . . | . . . |

In Table 1, the “vector number” is a sequential number for the management of vectors. The vector number is assigned in order of the vectors stored in the expression vector repository. A vector generated the backbone network 130 is first stored in the expression vector repository 150. Next, vectors generated by the momentum network 130 are sequentially stored in the expression vector repository 150. If three or more view images are generated by the image data augmenter 120, an odd-numbered view image may be processed by the backbone network 130 and an even-numbered view image may be processed by the momentum network 140, and the processed odd-numbered and even-numbered view images may be vectorized. Thereafter, the vectors generated by the backbone network 130 and the momentum network 140 may be alternately stored in the expression vector repository 150. Accordingly, vectors of views converted into the same original image are consecutively stored in the expression vector repository 150.

The “image unique ID” indicates a unique ID of the original image that is used in the image data augmenter 120 in order to generate a vector. The image unique ID may consist of a location where the original image is stored and a file name. A memory location where a corresponding vector value is stored is recorded at a vector storage location.

Furthermore, it is preferred that in an efficient viewpoint, the size of the expression vector repository 150 is the same as a vector batch size, that is, the product of an image data batch size and the number of view images generated from each original image. The expression vector repository 150 is updated whenever the batch of the original images is constructed. Thereafter, the sample checker 160 and the loss calculator 170 calculate a cosine distance between vectors in Equation 3 in a vector batch unit and a loss value in Equation 4, respectively, and store the cosine distance and the loss value in the data table of the expression vector repository 150.

$${s}_{ij} = {z}_{i} \cdot {z}_{j} / ( ‖ {z}_{i} ‖ ‖ {z}_{j} ‖ \qquad ( 3 )$$

$$loss = {\sum }_{i + 1}^{cN} ( - \frac{1}{\vert P ( i ) \vert} ) {\sum }_{p ∈ P ( i )} log ( exp ( \frac{{s}_{ij}}{τ} ) ) / ( {\sum }_{k = 1}^{cN} ( {1}_{k ∈ A ( i )} exp ( \frac{{s}_{ik}}{τ} ) ) ) \qquad ( 4 )$$

In Equation 3, zᵢ and zⱼ are expression vectors of the expression vector repository 150, which are output from the projector 132 of the backbone network 130 and the momentum projector 142 of the momentum network 140, respectively. Sᵢⱼ indicates a cosine distance value between a vector i and a vector j.

Furthermore, Equation 4 is a loss function. N is the batch size of non-index object images. cN indicates the batch size of expression vectors for a case in which c view images are generated with respect to each original image. Furthermore, P(i) is a set of all of positive samples for an anchor vector i. |P(i)| indicates the cardinality of the set P(i). τ is a scalar temperature parameter that is commonly used. 1_{k∈A(i)} has a value of 1 when a vector k is a negative sample. Equation 4 functions to draw positive samples having great similarity in a vector space closely and also to make negative samples far away.

The sample checker 160 classifies the view images into a positive sample and a negative sample based on an anchor vector selected in the batch of the expression vectors. The sample checker 160 selects an anchor vector (e.g., a sample type value=2), that is, a reference for checking similarity in the batch of the expression vectors, and calculates a cosine distance between view images converted from the same original image as the anchor vector. Furthermore, the sample checker 160 compares the calculated cosine distance with a preset positive sample reference Sp, classifies the view images into a positive sample (e.g., a sample type value=0) and a negative sample (e.g., a sample type value=1), and stores the positive sample and the negative sample in the expression vector repository 150.

Furthermore, the sample checker 160 compares a cosine distance between view images converted from the original image different from the anchor vector with the positive sample reference Sp, and may determine that the original image belongs to the same class as the original image of the anchor when all of the view images converted from the same original image are positive samples.

The positive sample reference Sp needs to be adjusted depending on the pre-trained encoder 131 and the momentum encoder 141 that are used in learning. It is preferred that the positive sample reference starts from about 0.8 in the early stage of learning and is gradually increased to a value close to 1 according to a learning process. Accordingly, learning efficiency can be improved by incorporating performance improvement according to the learning of the encoder.

The loss calculator 170 calculates a loss value of a loss function based on a distance value between the anchor vector and the expression vector, and updates the parameter 132 of the backbone network 130 by reversely propagating the loss value of the loss function to the backbone network 130. That is, the loss calculator 170 calculates the loss value in the loss function of Equation 4 based on a distance value between each anchor checked in the sample checker 160 and another view image. The loss value calculated as described above is reversely propagated into the backbone network 130, and may be used to update the parameter value of the backbone network 130.

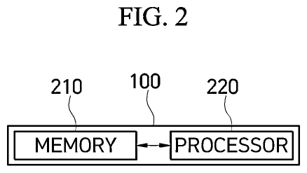

FIG. 2 is a block diagram of the apparatus 100 for SSCL according to an embodiment of the present disclosure.

The apparatus 100 for SSCL according to an embodiment of the present disclosure includes memory 210 and a processor 220.

The memory 210 stores a non-index object image necessary for learning and an expression vector corresponding to the non-index object image, and stores programs for SSCL based on the non-index object image. In this case, the memory 210 commonly refers to a nonvolatile storage device that retains information stored therein although power is not supplied to the nonvolatile storage device and a volatile storage device. For example, the memory 210 may include NAND flash memory such as a compact flash (CF) card, a secure digital (SD) card, a memory stick, a solid-state drive (SSD), and a micro SD card, a magnetic computer memory device such as a hard disk drive (HDD), and an optical disc drive such as CD-ROM and DVD-ROM.

The processor 220 may control at least one different component (e.g., hardware or software component) of the apparatus 100 for SSCL by executing software, such as a program, and may perform various data processing or operations.

As the processor 220 executes the program stored in the memory 210, the processor 220 generates a plurality of different view images by applying at least one conversion scheme for SSCL to a non-index object image, and generates expression vectors by alternately inputting the plurality of view images to the backbone network 130 and the momentum network 140.

Furthermore, the processor 220 classifies the plurality of view images into a positive sample and a negative sample based on an anchor vector selected in the batch of the expression vectors, calculates the loss value of a loss function based on a distance value between the anchor vector and the expression vector, and updates the parameter of the backbone network 130 by reversely propagating the loss value of the loss function to the backbone network 130.

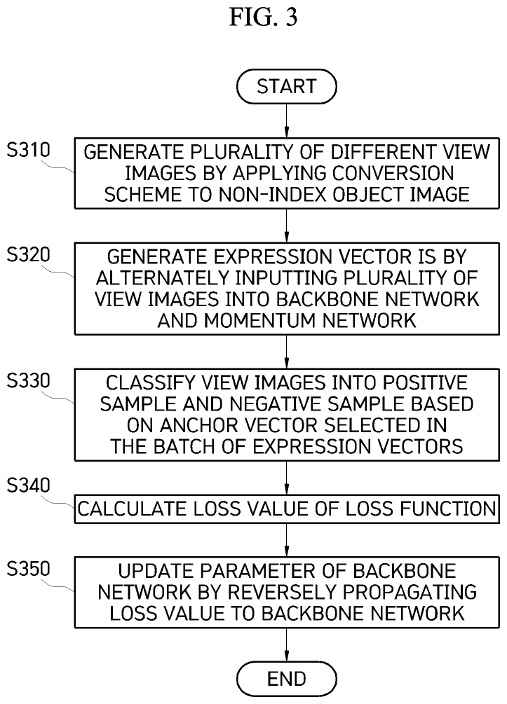

Hereinafter, a method that is performed by the apparatus for SSCL according to an embodiment of the present disclosure is described more specifically with reference to FIGS. 3 to 6.

FIG. 3 is a flowchart of a method for SSCL according to an embodiment of the present disclosure.

In an embodiment of the present disclosure, first, a plurality of different view images is generated by applying at least one conversion scheme for SSCL to a non-index object image that has been previously stored (S310).

Next, an expression vector is generated by alternately inputting the plurality of view images into the backbone network and the momentum network (S320).

Next, the view images are classified into a positive sample and a negative sample based on an anchor vector selected in the batch of the expression vectors (S330).

Next, a loss value of a loss function based on a distance value between the anchor vector and the expression vector is calculated (S340). The parameter of the backbone network is updated by reversely propagating the loss value of the loss function to the backbone network (S350). When an update by the batch of vectors is repeated and performed in an epoch unit, the parameters of the momentum network may be updated by applying Equation 1 and Equation 2.

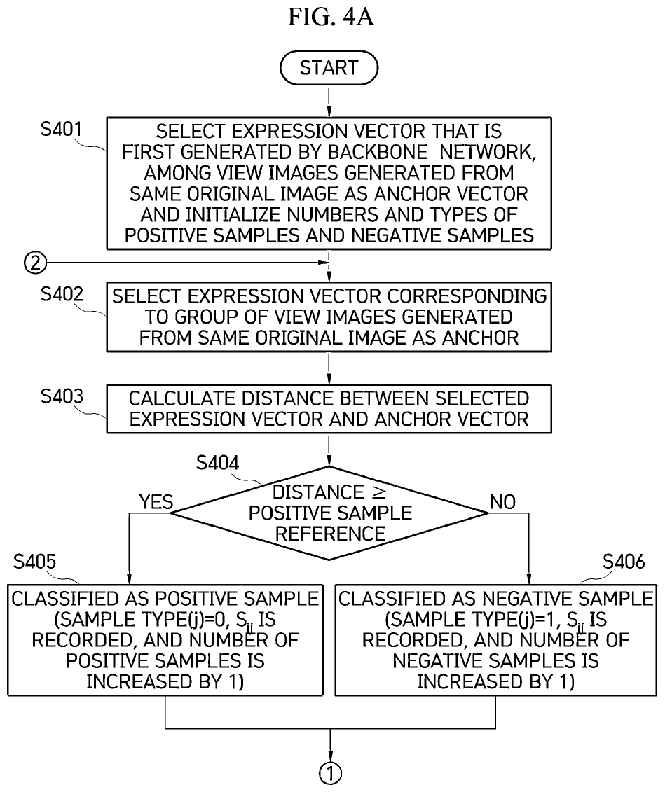

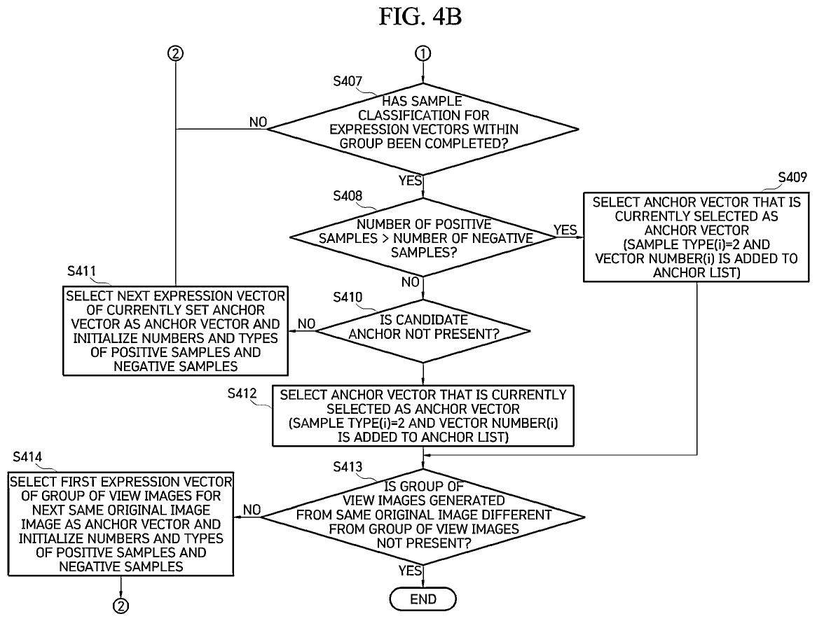

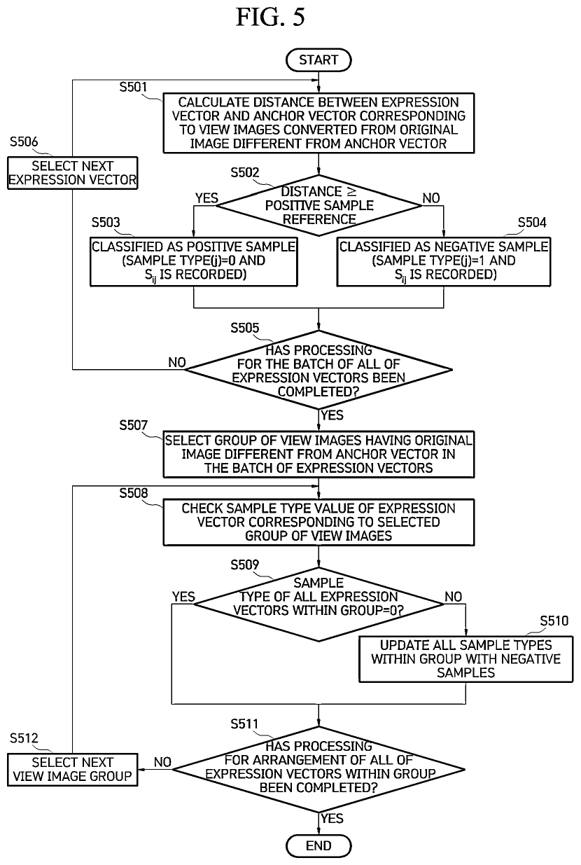

FIGS. 4A and 4B are diagrams for describing a process of selecting an anchor vector and a process of classifying a positive sample and a negative sample in an embodiment of the present disclosure. In this case, FIGS. 4A, 4B, and 5 illustrate processes that are performed by the sample checker.

Specifically, in an embodiment of the present disclosure, an expression vector that is first generated by the backbone network, among view images generated from the same original image, is selected as an anchor vector (S401). In step S401, the numbers and types of positive samples and negative samples are initialized.

Next, an expression vector corresponding to a group of view images generated from the same original image as the anchor of the anchor vector is selected (S402). A distance between the selected expression vector and the anchor vector is calculated (S403).

Next, the calculated distance is compared with a preset positive sample reference (S404). The view images within the group are classifies into a positive sample and a negative sample based on the results of the comparison. That is, when the calculated distance is equal to or greater than the preset positive sample reference as a result of the comparison, the view image is classified as the positive sample, and a sample type value within the expression vector repository is recorded as 0 (S405) (i.e., sample type (j)=0, Sᵢⱼ is recorded, and the number of positive samples is increased by 1). In contrast, when the calculated distance is less than the preset positive sample reference, the view image is classified as the negative sample, and a sample type value within the expression vector repository is recorded as 1 (S406) (i.e., sample type (j)=1, Sᵢⱼ is recorded, and the number of negative samples is increased by 1).

Next, whether sample classification for the view images within the group, which are converted from the same original image, has been fully completed is determined (S407). If the sample classification has not yet been completed, steps subsequent to step S402 are repeated and performed.

In contrast, if the sample classification has been fully completed, the numbers of positive samples and negative samples are counted (S408). Furthermore, when the number of positive samples is greater than the number of negative samples as a result of the counting, an anchor vector that is currently selected is selected as an anchor vector, that is, a reference (S409). That is, sample type (i)=2 is recorded with respect to a current anchor, and vector number (i) is added to an anchor list.

In contrast, when the number of positive samples is not greater than the number of negative samples as a result of the counting, whether a candidate anchor for the expression vector included in the group of view images generated from the same original image is present is determined (S410). When the candidate anchor for the expression vector is present, a next expression vector of a currently set anchor vector is selected as an anchor vector (S411). In step S411, the numbers and types of positive samples and negative samples are initialized.

When a candidate anchor for the expression vector included in the group of view images generated from the same original image is no longer present, an anchor vector that is currently selected is selected as an anchor vector, that is, a reference (S412). That is, sample type (i)=2 is recorded with respect to a current anchor, and vector number (i) is added to the anchor list.

Next, whether a group of view images generated from the same original image different from the group of view images is present is determined (S413). When the group of view images generated from the same original image different from the group of view images is present as a result of the determination, the first expression vector of a group of view images for a next same original image is selected as an anchor vector and the numbers and types of positive samples and negative samples are initialized (S414). Thereafter, steps subsequent to step S402 may be repeated and performed.

FIG. 5 is a diagram for describing a sample classification process in a view image different from an anchor vector in an embodiment of the present disclosure.

First, a distance Sᵢₖ between an expression vector and an anchor vector corresponding to view images converted from the original image different from an anchor vector, is calculated (S501).

Next, the calculated distance is compared with a preset positive sample reference (S502). The view images are classified into a positive sample and a negative sample based on the results of the comparison (S503 and S504).

That is, when the calculated distance is equal to or greater than the preset positive sample reference as a result of the comparison, the view image is classified as the positive sample, and a sample type value within the expression vector repository is recorded as 0 (S503) (i.e., sample type (j)=0 and Sᵢⱼ is recorded). In contrast, when the calculated distance is less than the preset positive sample reference, the view image is classified as the negative sample, and the sample type value within the expression vector repository is recorded as 1 (S504) (i.e., sample type (j)=1 and Sᵢⱼ is recorded).

Next, whether processing for the batch of all of the expression vectors corresponding to the view images converted from the original image different from the anchor vector has been completed is determined (S505). When a remaining expression vector is present, a next expression vector is selected, and steps subsequent to step S501 is repeated and performed (S506).

In contrast, when the processing for the batch of all of the expression vectors is completed, a group of view images having an original image different from the anchor vector is selected in the batch of the expression vectors (S507). A sample type value of an expression vector corresponding to the selected group of view images is checked (S508).

Furthermore, when at least one negative sample is present in the sample type of the expression vector corresponding to the selected group of view images as a result of the check (S509), all of the sample types for the group of view images are updated with negative samples (sample type=1) (S510).

Next, whether the processing of the batch of the expression vectors corresponding to the group of all of the view images has been completed is checked (S511). If processing for another view image group is required, steps subsequent to step S507 are repeated and performed (S512).

Through such a process, all of the views of the same original image are determined as positive samples only when all of the views of the same original image are positive samples with respect to an anchor. This is applied to a subsequent process of calculating a loss value.

In the description of the present disclosure, after all of positive samples or negative samples between an anchor and all of view images are determined, whether the same original image views are positive or negative samples has been updated. However, according to an implementation method, whether image views are positive or negative samples may be determined by dividing the image views by the same original image group.

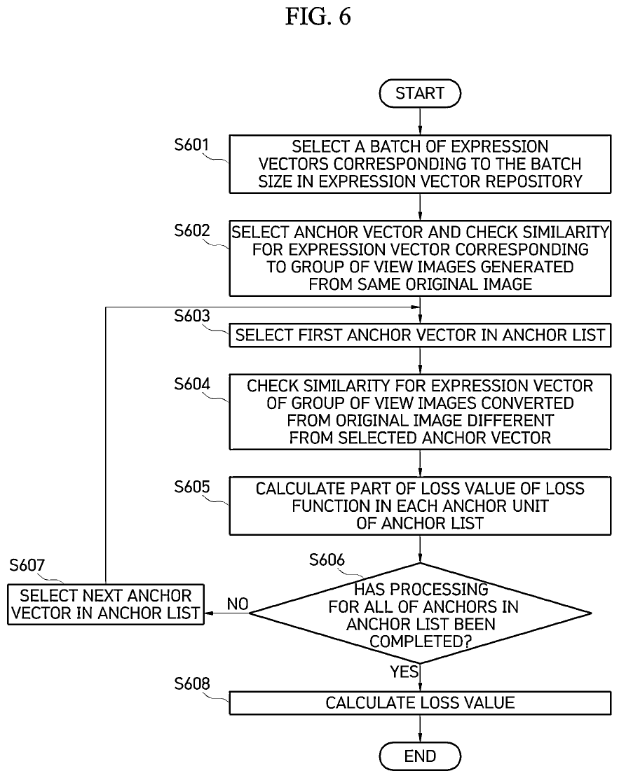

FIG. 6 is a diagram illustrating a flow of an operation that is performed by a sample checker and a loss calculator according to an embodiment of the present disclosure. In this case, steps illustrated in FIG. 6 includes steps illustrated in FIGS. 4A, 4B, and to 5.

First, in the expression vector repository, the batch of expression vectors corresponding to the batch size is selected (S601).

Next, a process of selecting an anchor vector is performed, and similarity for an expression vector corresponding to a group of view images generated from the same original image is checked (S602).

Next, the first anchor vector in an anchor list is selected (S603). Similarity for an expression vector of a group of view images converted from an original image different from the selected anchor vector is checked (S604).

Next, a part

$$( log ( exp ( \frac{{s}_{ij}}{τ} ) ) / ( {\sum }_{k = 1}^{cN} ( {1}_{k \neq A ( i )} exp ( \frac{{s}_{ik}}{τ} ) ) ) )$$

of a loss value of a loss function is calculated in each anchor unit of the anchor list (S605). Whether processing for all of the anchors in the anchor list has been completed is checked (S606). When there is an anchor that has not been processed, steps subsequent to step S603 are repeated and performed (S607).

In contrast, when the processing for all of the anchors in the anchor list has been completed, a loss value is finally calculated (S608). The calculated loss value is reversely propagated and transferred.

In the aforementioned description, each of steps S310 to S608 may be further divided into additional steps or the steps may be combined into smaller steps depending on an implementation example of the present disclosure. Furthermore, some of the steps may be omitted, if necessary, and the sequence of the steps may be changed. Furthermore, although contents are omitted, the contents described with reference to FIGS. 1 and 2 and the contents described with reference to FIGS. 3 to 6 may be mutually applied.

The method for SSCL according to an embodiment of the present disclosure may be implemented in the form of a program (or application) in order to be executed by being combined with a computer, that is, hardware, and may be stored in a medium.

The aforementioned program may include a code coded in a computer language, such as C, C++, JAVA, Ruby, or a machine language which is readable by a processor (CPU) of a computer through a device interface of the computer in order for the computer to read the program and execute the methods implemented as the program. Such a code may include a functional code related to a function, etc. that defines functions necessary to execute the methods, and may include an execution procedure-related control code necessary for the processor of the computer to execute the functions according to a given procedure. Furthermore, such a code may further include a memory reference-related code indicating at which location (address number) of the memory inside or outside the computer additional information or media necessary for the processor of the computer to execute the functions needs to be referred. Furthermore, if the processor of the computer requires communication with any other remote computer or server in order to execute the functions, the code may further include a communication-related code indicating how the processor communicates with the any other remote computer or server by using a communication module of the computer and which information or media needs to be transmitted and received upon communication.

The stored medium means a medium, which semi-permanently stores data and is readable by a device, not a medium storing data for a short moment like a register, cache, or a memory. Specifically, examples of the stored medium include ROM, RAM, CD-ROM, a magnetic tape, a floppy disk, optical data storage, etc., but the present disclosure is not limited thereto. That is, the program may be stored in various recording media in various servers which may be accessed by a computer or various recording media in a computer of a user. Furthermore, the medium may be distributed to computer systems connected over a network, and a code readable by a computer in a distributed way may be stored in the medium.

The description of the present disclosure is illustrative, and a person having ordinary knowledge in the art to which the present disclosure pertains will understand that the present disclosure may be easily modified in other detailed forms without changing the technical spirit or essential characteristic of the present disclosure. Accordingly, it should be construed that the aforementioned embodiments are only illustrative in all aspects, and are not limitative. For example, elements described in the singular form may be carried out in a distributed form. Likewise, elements described in a distributed form may also be carried out in a combined form.

The scope of the present disclosure is defined by the appended claims rather than by the detailed description, and all changes or modifications derived from the meanings and scope of the claims and equivalents thereto should be interpreted as being included in the scope of the present disclosure.

[Description of reference numerals]

| | |
|---|---|
| 100: apparatus for SSCL | |
| 110: image data repository | |
| 120: image data augmenter | |
| 130: backbone network | 140: momentum network |
| 150: sample checker | 160: loss calculator |

What is claimed is:

1. A method for self-supervised contrastive learning (SSCL), the method being performed by a computer and comprising:
generating a plurality of different view images by applying at least one conversion scheme for SSCL to a pre-stored non-index object image;
generating expression vectors by alternately inputting the plurality of view images to a backbone network and a momentum network initialized to have an identical network parameter values;
classifying the plurality of view images into a positive sample and a negative sample based on an anchor vector selected in a batch of the expression vectors;
calculating a loss value of a loss function based on a distance value between the anchor vector and the expression vector; and
updating parameters of the backbone network and the momentum network by reversely propagating the loss value of the loss function to the backbone network.

2. The method of claim 1, wherein the classifying of the plurality of view images into the positive sample and the negative sample based on the anchor vector selected in the batch of the expression vectors comprises selecting, as the anchor vector, an expression vector that is first generated by the backbone network, among the view images generated by the identical original image.

3. The method of claim 1, wherein the classifying of the plurality of view images into the positive sample and the negative sample based on the anchor vector selected in the batch of the expression vectors comprises:
calculating a distance between the expression vector and the anchor vector corresponding to a group of the view images generated from an original image identical with an anchor of the anchor vector;
comparing the calculated distance with a preset positive sample reference; and
classifying the view images within the group into the positive sample and the negative sample based on results of the comparison.

4. The method of claim 3, wherein the classifying of the plurality of view images into the positive sample and the negative sample based on the anchor vector selected in the batch of the expression vectors comprises:
counting numbers of the positive samples and the negative samples when sample classification for the view images within the group, which are converted from the identical original image is completed; and
selecting an anchor vector that is currently selected as the anchor vector that is the reference when the number of positive samples is greater than the number of negative samples as a result of the counting.

5. The method of claim 4, wherein the classifying of the plurality of view images into the positive sample and the negative sample based on the anchor vector selected in the batch of the expression vectors comprises selecting a next expression vector of a currently set anchor vector as the anchor vector when the number of positive samples is not greater than the number of negative samples as a result of the counting.

6. The method of claim 5, wherein the classifying of the plurality of view images into the positive sample and the negative sample based on the anchor vector selected in the batch of the expression vectors comprises selecting an anchor vector that is currently selected as the anchor vector that is the reference, when the number of positive samples is not greater than the number of negative samples as a result of the counting and a candidate anchor for the expression vector included in the group of the view images generated from the identical original image is no longer present.

7. The method of claim 1, wherein the classifying of the plurality of view images into the positive sample and the negative sample based on the anchor vector selected in the batch of the expression vectors comprises:
calculating a distance between the expression vector and the anchor vector corresponding to view images converted from an original image different from the anchor vector;
comparing the calculated distance with a preset positive sample reference; and
classifying the view images into the positive sample and the negative sample based on results of the comparison.

8. The method of claim 7, wherein the classifying of the plurality of view images into the positive sample and the negative sample based on the anchor vector selected in the batch of the expression vectors comprises:
selecting a group of view images having an original image different from the anchor vector in the batch of the expression vectors; and
updating all types of samples for the group of the view images with the negative sample when at least one negative sample is present in a sample type of an expression vector corresponding to the selected group of the view images.

9. An apparatus for self-supervised contrastive learning (SSCL), comprising:
an image data repository configured to store a non-index object image necessary for learning;
an image data augmenter configured to generate a plurality of different view images by applying at least one conversion scheme for SSCL to the non-index object image;
a backbone network and a momentum network each configured to generate expression vectors by alternately receiving the plurality of view images and initialized to have an identical network parameter values;
an expression vector repository configured to store the expression vectors generated by the backbone network and the momentum network;
a sample checker configured to classify the plurality of view images into a positive sample and a negative sample based on an anchor vector selected in a batch of the expression vectors; and
a loss calculator configured to calculate a loss value of a loss function based on a distance value between the anchor vector and the expression vector and to update parameters of the backbone network and the momentum network by reversely propagating the loss value of the loss function to the backbone network.

10. The apparatus of claim 9, wherein the sample checker selects, as the anchor vector, an expression vector that is first generated by the backbone network, among the view images generated by the identical original image.

11. The apparatus of claim 9, wherein the sample checker calculates a distance between the expression vector and the anchor vector corresponding to a group of the view images generated from an original image identical with an anchor of the anchor vector, compares the calculated distance with a preset positive sample reference, and classifies the view images within the group into the positive sample and the negative sample based on results of the comparison.

12. The apparatus of claim 11, wherein the sample checker counts numbers of the positive samples and the negative samples when sample classification for the view images within the group, which are converted from the identical original image is completed, and selects an anchor vector that is currently selected as the anchor vector that is the reference when the number of positive samples is greater than the number of negative samples as a result of the counting.

13. The apparatus of claim 12, wherein the sample checker selects a next expression vector of a currently set anchor vector as the anchor vector when the number of positive samples is not greater than the number of negative samples as a result of the counting.

14. The apparatus of claim 13, wherein the sample checker selects an anchor vector that is currently selected as the anchor vector that is the reference, when the number of positive samples is not greater than the number of negative samples as a result of the counting and a candidate anchor for the expression vector included in the group of the view images generated from the identical original image is no longer present.

15. The apparatus of claim 9, wherein the sample checker calculates a distance between the expression vector and the anchor vector corresponding to view images converted from an original image different from the anchor vector, compares the calculated distance with a preset positive sample reference, classifies the view image as the positive sample when the view image is within the positive sample reference, and classifies the view image as the negative sample when the view image is not within the positive sample reference.

16. The apparatus of claim 15, wherein the sample checker selects a group of view images having an original image different from the anchor vector in a batch of the expression vectors, and updates all types of samples for the group of the view images with the negative sample when at least one negative sample is present in a sample type of an expression vector corresponding to the selected group of the view images.

17. An apparatus for self-supervised contrastive learning (SSCL), comprising:
memory in which a non-index object image necessary for learning, an expression vector corresponding to the non-index object image, and a program for SSCL based on the non-index object image are stored; and
a processor configured to execute the program stored in the memory,
wherein by executing the program, the processor
generates a plurality of different view images by applying at least one conversion scheme for SSCL to the non-index object image,
generates expression vectors by alternately inputting the plurality of view images to a backbone network and a momentum network initialized to have an identical network parameter values,
classifies the plurality of view images into a positive sample and a negative sample based on an anchor vector selected in a batch of the expression vectors,
calculates a loss value of a loss function based on a distance value between the anchor vector and the expression vector, and
updates parameters of the backbone network and the momentum network by reversely propagating the loss value of the loss function to the backbone network.
